(19) United States
(12) Patent Application Publication
(10) Pub. No.: US 2006/0186237 A1
(43) Pub. Date: Aug. 24, 2006

(54) Hydraulic pump drive system

(76) Inventor: Steve Charles Koontz, Livingston, MT (US)

Correspondence Address: STEVE KOONTZ, 1007 EAGLE CT., LIVINGSTON, MT, 59047, US

(21) Appl. No.: 11/063,695

(22) Filed: Feb. 22, 2005

(51) Int. Cl. B02C 19/00

(52) U.S. Cl. 241/101.2

(57) ABSTRACT

This invention is new to the art of driving hydraulic pumps because up to now hydraulic pumps have been driven by electric motors or separate engines of some kind. Now with this invention extra motors and engines are unnecessary. Implementation of this invention requires that the crusher be driven by a driveshaft. Then the main sheave is free to drive an auxiliary jack shaft that drives a transfer case. This transfer case in turn is used to drive multiple hydraulic pumps.

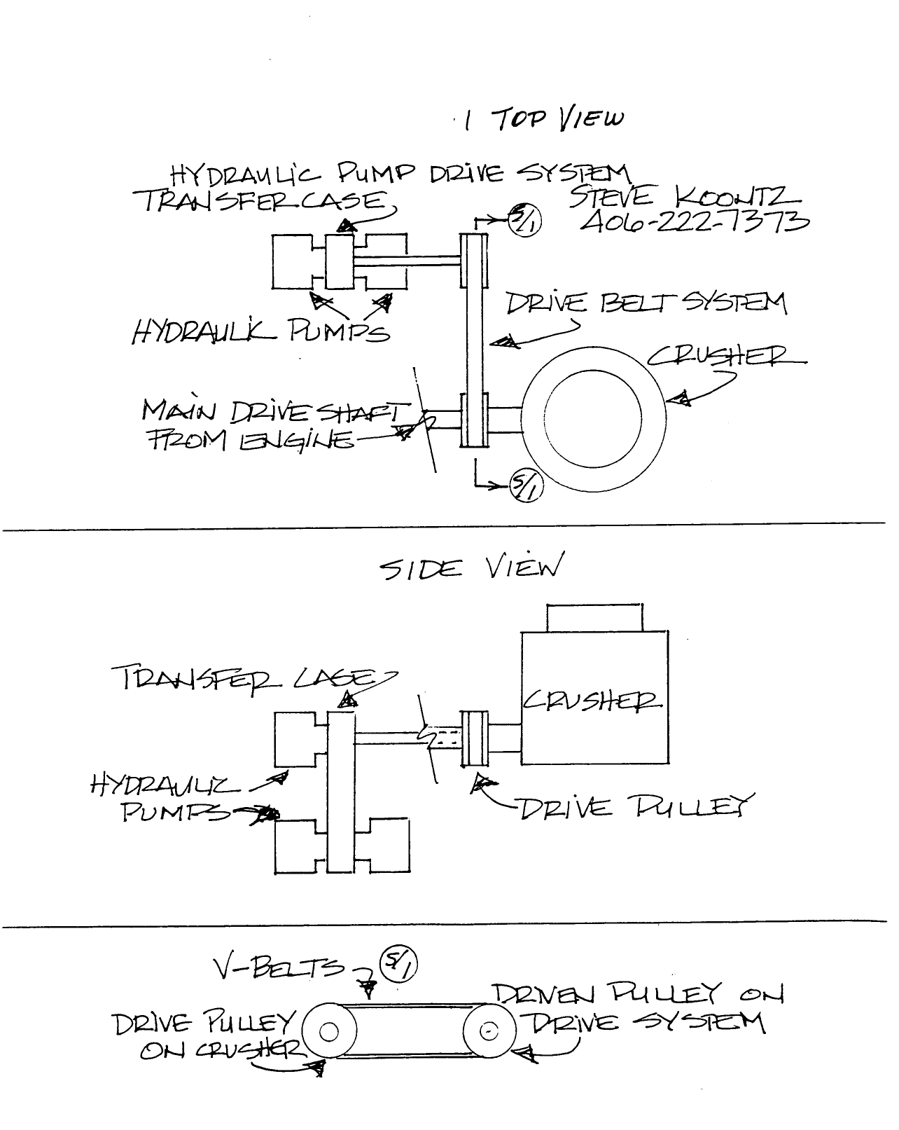

### BACKGROUND OF THE INVENTION

Portable rock crushing plants are typically powered by electrical generator sets. The electricity is used to run electric motors that power each individual component that make up the plant.

This current generator powered system has many drawbacks:
A. Safety—Electricity used in this application is always a safety concern. Electricity is a source of many injuries and deaths. At the annual refresher courses put on by the Mining Safety and Health Administration (MSHA, a federal agency), there is consistently a considerable amount of time set aside for discussing electricity related safety issues.
Expense-cost of purchase—Generator sets and the related control panels are very expensive. Electric drive motors used on conveyors all require clear reduction drives, which are also very costly.
Expense-cost of operation—Using electricity to run a rock crushing plant is not the most cost effective method. By substituting hydraulics for electricity one can experience a reduction of operating cost.
Expense-cost of maintenance—Electricity, when used in this application, is always a problem. Relays often fail and are expensive to replace. Motors, when accidentally overloaded, burn out and must be replaced, which again is costly. In contrast, when a hydraulic motor is overloaded it merely stalls and sustains no damage.

### BRIEF SUMMARY OF THE INVENTION

The belt drive used to drive the crusher is converted over so that it can be used to drive an auxiliary hydraulic pump system. A direct drive shaft is now used to drive the crusher unit.

### DESCRIPTION OF DRAWINGS

A) Top View. This shows a typical lay out of the crusher, drive belt system, transfer case, and the hydraulic pumps.

B) Side View. This shows how the pumps are positioned.

C) Section through drive belts.

### DETAILED DESCRIPTION OF THE INVENTION

This is a V-belt drive system that is powered by the pulley which is usually used to drive the crusher.

The power is carried by the V-belts from the crusher pulley to a pulley that drives a transfer case.

The transfer case can drive three separate pumps.

The crusher is now powered by a direct drive shaft.

1. What I claim as my invention is a hydraulic pump drive system comprising:
a. the existing driven sheave normally used to power the crusher
b. said sheave driving belts to a sheave on a jack shaft
c. said jack shaft driving a transfer case
d. said transfer case driving two or more hydraulic pumps.
